(19) United States
(12) Patent Application Publication
(10) Pub. No.: US 2025/0238655 A1
(43) Pub. Date: Jul. 24, 2025

(54) MINING COLLABORATION NETWORK SIGNALS TO GENERATE PROCESS OPTIMIZATION RECOMMENDATION USING AI

(71) Applicant: Microsoft Technology Licensing, LLC, Redmond, WA (US)

(72) Inventors: Ryan James D’AURELIO, Seattle, WA (US); Andres SARMIENTO TOBON, Redmond, WA (US); Eveleen Kai-Eve SUNG, Seattle, WA (US); Ryan Mathew WEDOFF, Lynnwood, WA (US); Chiderah ONUORAH, Seattle, WA (US); Peng BIAN, Kenmore, WA (US)

(21) Appl. No.: 18/593,509

(22) Filed: Mar. 1, 2024

Related U.S. Application Data
(60) Provisional application No. 63/622,203, filed on Jan. 18, 2024.

(51) Int. Cl. G06N 3/042; G06N 3/0475

(52) U.S. Cl. CPC G06N 3/042; G06N 3/0475

(57) ABSTRACT

The described technology provides a method including receiving a plurality of user signals from one or more collaboration networks, wherein the plurality of signals are clustered with reference to a relevant user node, extracting a plurality of key data relating to the relevant user node, generating an optimization prompt using the key data, inputting the optimization prompt into a machine learning model, and using the machine learning model, generating an optimization recommendation in response to receiving the optimization prompt, and modifying a process using the process automation recommendation.

### CROSS-REFERENCE TO RELATED APPLICATIONS

This application is a non-provisional application based on and takes priority from pending U.S. provisional application Ser. No. 63/622,203, entitled “Mining collaboration network signals to generate process optimization recommendation using AI,” which was filed on Jan. 18, 2024. The disclosure set forth in the referenced application is incorporated herein by reference in its entirety.

### BACKGROUND

Collaboration networks for sharing emails, messages, documents, tasks, for conducting meetings, and managing projects, etc., are highly prevalent in modern enterprises. Such collaboration networks generate a large number of signals and data. Such data include interactions among the users as they participate in various collaborative processes as well as the user's interaction with applications and processes of the collaboration networks.

### SUMMARY

The described technology provides a method including receiving a plurality of user signals from one or more collaboration networks, wherein the plurality of signals are clustered with reference to a relevant user node, extracting a plurality of key data relating to the relevant user node, generating an optimization prompt using the key data, inputting the optimization prompt into a machine learning model, and using the machine learning model, generating an optimization recommendation in response to receiving the optimization prompt, and modifying a process using the process automation recommendation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example implementation of a system for mining collaboration network signals to generate process optimization recommendation using AI.

FIG. 2 illustrates an alternative example implementation of a system for mining collaboration network signals to generate process optimization recommendation using AI.

FIG. 3 illustrates an alternative example implementation of a system for mining collaboration network signals to generate process optimization recommendation using AI.

FIG. 4 illustrates an alternative example implementation of a system for mining collaboration network signals to generate process optimization recommendation using AI.

FIG. 5 illustrates an example flowchart of operations for mining collaboration network signals to generate process optimization recommendation using AI.

FIG. 6 illustrates an example system that may be useful in implementing the collaboration network mining technology disclosed herein.

### DETAILED DESCRIPTIONS

Collaboration networks for sharing emails, messages, documents, tasks, for conducting meetings, and managing projects, etc., are highly prevalent in modern enterprises. Such collaboration networks generate a large number of signals and data. Such data include interactions among the users as they participate in various collaborative processes as well as the user's interaction with applications and processes of the collaboration networks.

The technology disclosed herein allows optimization of processes used by various users of the collaboration networks based on the data collected and insights extracted from the usage of the various applications underlying the collaboration networks. The implementations disclosed herein generates such optimizations and provides suggestions to the users. The underlying applications may include an email application, a file and document sharing application, a business chat application, an online meeting application, etc. Examples of the optimization suggestions may include proactive suggestions such as generic pre-aggregated suggestions based on user behavior and contextual pre-aggregated suggestions based on their behavior in a specific context. Alternatively, the suggestions may include contextual pre-aggregated suggestions based on user prompt in a specific context.

The implementations of the system for mining collaboration network signals to generate process optimization recommendation using AI as disclosed herein allows portability such that it seamlessly adapts across various platforms, thus ensuring flexibility and accessibility for all users. The implementations disclosed herein links a substrate with an AI integrator. However, the implementation is kept open-ended for connecting to other future data sources and user entrance points. Here the substrate provides a wealth of data from the user's interactions and use of one or more collaboration networks. Furthermore, the implementations disclosed herein provides user accessibility through application programming interface (API) or direct call to the application so that it has capacity to draw in a multitude of new users without introducing any barriers or complications.

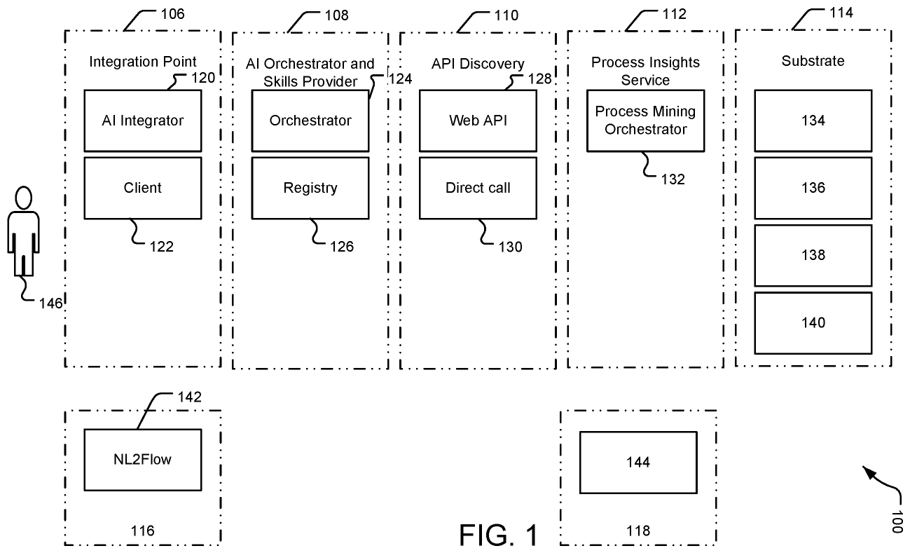

FIG. 1 illustrates an implementation of a system 100 for mining collaboration network signals to generate process optimization recommendation using AI. Specifically, the system 100 includes a substrate 114 supporting various applications 134-138. The substrate 114 has the capability to unite data from the various applications and it also provides range of capabilities including storage, security, and compliance. Example applications 134-138 may include an email application, a file and document sharing application, a business chat application, an online meeting application, etc. The substrate 114 may store various data or references to the data related to the user's using the applications 134-138. Example of an application may be a process insights substrate application 134 that generates insights into the use of the data by various users. A substrate collaboration application 136 that provides an array of web-based tools that support work in a distributed development environment. A substrate profile application 138 may store and manage profiles of various users of the collaboration network applications. One or more of the software development kits (SDK) provided by the substrate 114 may be used by users to build additional applications. Specifically, the applications 134-140 may communicate with each other to formulate the data.

The system 100 also includes a process insights services manager 112 that specifies the data sources inside the substrate 114 that are being aggregated and the configuration of the data. In one implementation, the substrate 112 may provide applications deployed directly in cloud or applications deployed inside backend of the substrate 112. A process mining orchestrator 132 may orchestrate the mining of the data and signals from the substrate 114 based on the manner in which the apps are deployed. The process mining orchestrator 132 is communicatively connected with a large language model (LLM) 144 inside an AI builder 118.

In the illustrated implementation of the system 100, an API discovery manager 110 exposes the AI builder 118 to users. In one implementation, the AI builder 118 maybe exposed using a web API 128, which uses an openAI specification that allows both computers and users to understand the capabilities of a REST API without direct access to the source code. Alternatively, users can access the AI builder 118 via a direct API call 130 to the AI builder 118.

An AI integrator 120, residing at an AI integration point 106, integrates the AI experience for a client 122 and its users 146.

An AI orchestrator 108 includes an AI orchestrator 124 and a registry 126. The AI orchestrator 124 generates prompts based on results generated by the process mining orchestrator 132. In one implementation, the AI integrator 120 may generate natural language prompts. The registry 126 provides a framework for skill discovery and pass in authentication and user context to the AI integrator 120. For example, the registry 126 provides various avenues for discovery. The Integration point 106 is communicatively connected with an automation module 116 that includes a natural language to workflow pairing (NL2Flow) module 142. The NL2Flow module may take the prompts generated by the AI integrator to generate a new process flow recommendation in response to the natural language prompt. In an alternative implementation, the AI integrator 120 may also provide prompts for the NL2Flow module 142 to generate recommendations for generating mobile or other applications (also referred to as apps), webpages, APIs, etc.

As an example, the substrate 114 may collect data related to use of various collaboration networks, such as mail, chat, etc., by a user Jane Doe. These data may include data about the group of people that Jane collaborates with, when she initiates a chat, when she reads and emails, initiates an email response, etc. The process insights services manager 112 extracts various key phrases, key applications, key collaborators, and other contextual information such as roles of the users, etc. Example of such key data may be as provided below:

Key apps: Outlook, SharePoint, Teams, OneDrive, Excel, Forms, ADO
Key entities from substrate data: Teams meeting, Teams chat, Teams meeting, Teams chat,
Teams chat, Outlook email, Office document, Teams chat, Teams chat
Key Individuals: Jane Doe (jane.doe@company.com), John Smith
(john.smith@company.com)

The AI integrator 120 may create a natural language prompt. An example of such a prompt may be:
“Create a flow that runs at the start of every month which retrieves finance and customer experience data from Azure Power BI, process it using Excel Online to calculate impact on Geranium plan and ACR trends due to CX data, and then send an email with the prompt attached to John Smith for review.”

Using generating AI, the automation module 116 may generate process optimization recommendation for the processes used by Jane. Specifically, the automation module 116 may use the NL2Flow module 142 to generate the process flow recommendation based on the natural language prompt. Alternatively, the NL2Flow module 142 generates recommendations for generating mobile or other applications, webpages, APIs, etc. For example, in one example, a recommendation for a mobile app that makes the processes more efficient may be generated by the NL2Flow module 142, wherein such a recommendation provides components of the mobile application such as input control components (buttons, text fields, toggles, check boxes, etc.), navigational components (menus sidebars, etc.), informational components (notifications, etc.), UI components, etc.

An example, of such a process flow recommendation generated by the automation module 116 is provided below:

Title: Monthly Finance Report Automation

| | |
|---|---|
| 1. | When a mew month starts, trigger the |
| | flow (Recurrence connector) |
| 2. | Get data from Azure Power BI dataset to |
| | retrieve finance and customer experience |
| | data (Power BI Connector) |
| 3. | Process the data using Excel online to |
| | calculate impact on Geranium plan and ACR |
| | trends due to CX data (Excel Online |
| | Connector) |
| 4. | Send an email to John Smith with the report |
| | attached for review (Outlook Connector) |

Subsequently, Jane may use this recommended optimized flow to generate monthly finance reports. The system 100 disclosed herein uses task mining from data at the substrate 114 to generate process automation recommendations to users. Specifically, providing the process mining orchestrator 132 at the substrate 114 allows the system to capture data as it is generated and cluster the data based on relationships based on the profiles of the users of the collaboration applications.

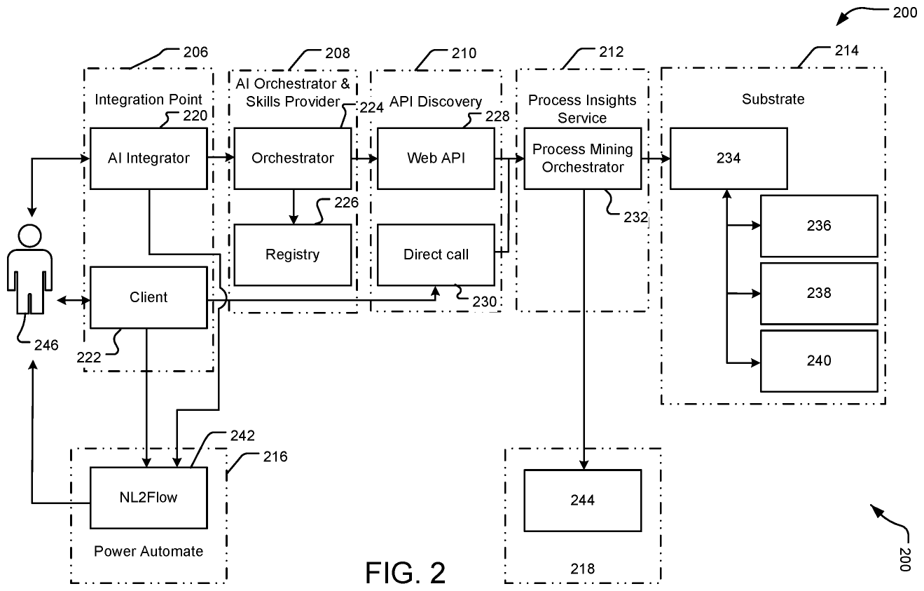

FIG. 2 illustrates an alternative implementation of a system 200 for mining collaboration network signals to generate process optimization recommendation using AI. Specifically, the system 200 includes a substrate 214 that supports various apps 234-140. For example, 234 may be a process-mining substrate app that communicates with a substrate profile app 236, a substrate collaboration network (CollabNet) app 238, and a substrate SIGS app The process-mining substrate app 234 may also communicate with a process mining orchestrator 232 that is configured as part of process insights service module 212. Furthermore, the process insights service module 212 communicates with an AI builder 218 that includes a large language model (LLM) 244. In one implementation, the LLM model 244 may deploy generative AI technology.

The process insights service module 212 generates insights into one or more processes that are communicated to the LLM 244 and the process mining app 234. In the illustrated implementation of the system 200, an API discovery manager 210 exposes the AI builder 218 to users. In one implementation, the AI builder 218 maybe exposed using a web API 228, which uses an openAI specification that allows both computers and users to understand the capabilities of a REST API without direct access to the source code. Alternatively, users can access the AI builder 218 via a direct API call 230 to the AI builder 218. Furthermore, An AI integrator 220, residing at an AI integration point 206, integrates the AI experience for a client 222 and its users 246.

An AI orchestrator & skills provider 208 includes an AI orchestrator 224 and a registry 226. The AI orchestrator 224 may generate prompts based on results generated by the process mining orchestrator 232. In one implementation, the AI integrator 220 may generate natural language prompts. The registry 226 provides a framework for skill discovery and passes in authentication and user context to the AI integrator 220. For example, the registry 226 provides various avenues for discovery. The Integration point 206 is communicatively connected with an automation module 216 that includes a natural language to workflow pairing (NL2Flow) module 242. The NL2Flow module 242 may take the prompts generated by the AI integrator 220 to generate a new process flow recommendation in response to the natural language prompt. In an alternative implementation, the AI integrator 220 may also provide prompts for the NL2Flow module 242 to generate recommendations for generating mobile or other applications (also referred to as apps), webpages, APIs, etc.

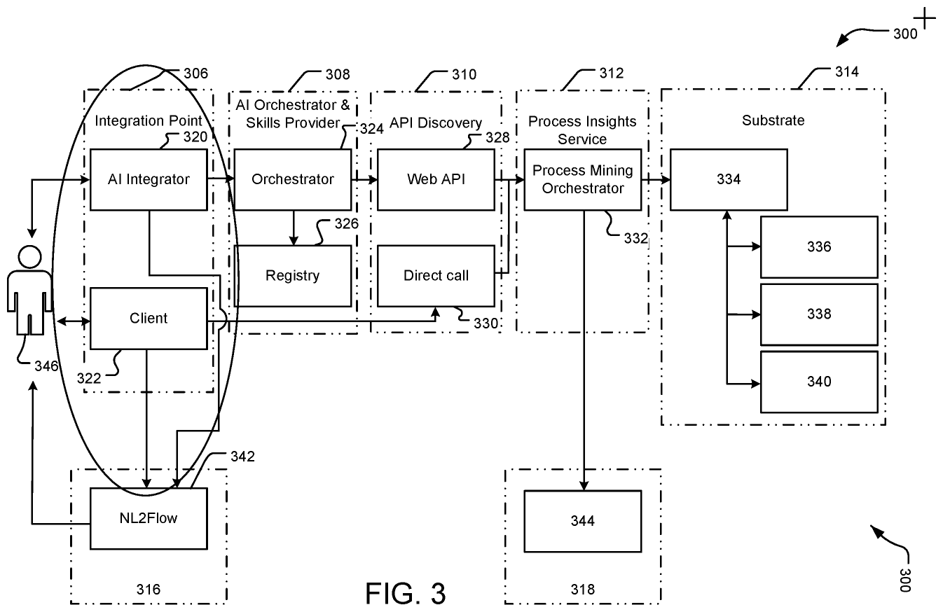

FIG. 3 illustrates an alternative implementation of a system 300 for mining collaboration network signals to generate process optimization recommendation using AI. One or more of the reference numerals 306-346 in FIG. 3 illustrate components that are similar to the components referenced by numerals 206-244 in FIG. 2. Specifically, the system 300 illustrates an implementation wherein the integration point 306 is unknown.

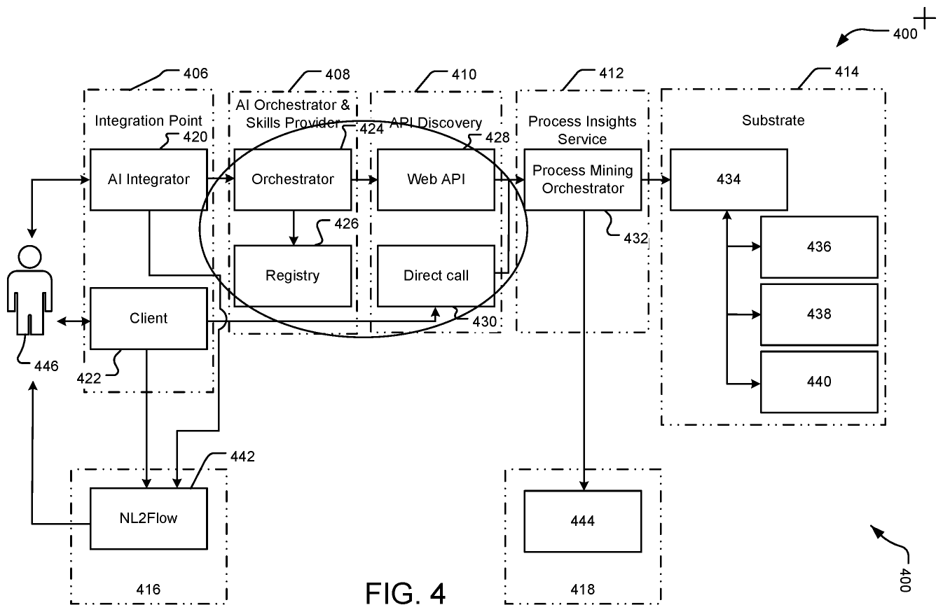

FIG. 4 illustrates an alternative implementation of a system 400 for mining collaboration network signals to generate process optimization recommendation using AI. One or more of the reference numerals 406-446 in FIG. 4 illustrate components that are similar to the components referenced by numerals 206-244 in FIG. 2. Specifically, the system 400 illustrates an implementation wherein the AI orchestrator & skills provider 308 and the API discovery manager 410 are unknown.

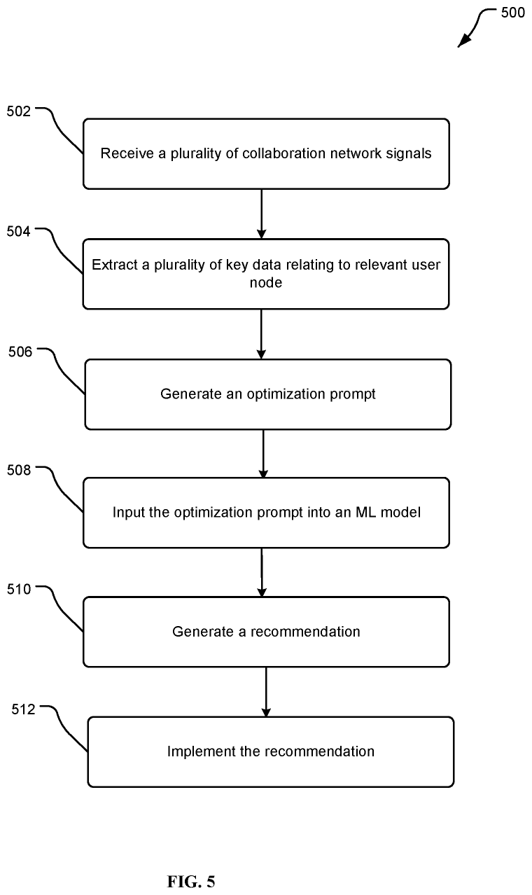

FIG. 5 illustrates a flowchart of operations 500 for mining collaboration network signals to generate process optimization recommendation using AI. Specifically, the operations 500 may be implemented using one of the systems 100-400 for mining collaboration network signals to generate process optimization recommendation using AI. An operation 502 receives a plurality of user signals from one or more collaboration networks. For example, the collaboration networks may include a mail network, a file sharing network, etc. In one implementation, the plurality of signals from the collaboration networks may be clustered with reference to a relevant user node. Subsequently, an operation 504 extracts a plurality of key data relating to the relevant user node.

An operation 506 generates an optimization prompt based on the key data. An example of such an optimization prompt is further disclosed above with reference to FIG. 1. An operation 508 inputs the optimization prompt into a machine learning model. In an implementation, such machine learning model may be an LLM implementing generative AI. An operation 510 generates at least one of a process automation recommendation, a process optimization recommendation, a mobile application recommendation, and a website layout recommendation in response to receiving the optimization prompt. An example of a process optimization recommendation may include, sending an email notification when a new file is added to a recordings directory. An example of a mobile application recommendation maybe, recommendation to create a new power app that monitors the recordings directory for new files and sends an email notification when a new file is added. Similarly, an example of a website layout recommendation maybe, a recommendation for creating a website that surfaces all the recordings in the recording directory and the layout for the surfacing of the recordings.

Subsequently, an operation 512 may implement the recommendation to modify a process, automate a process, optimize a process, generate a mobile app, or generate a website. Thus, for example, the operation 512 may send an email notification when a new file is added to a recordings directory, create a new power app that monitors the recordings directory for new files and sends an email notification when a new file is added, or create a website that surfaces all the recordings in the recording directory and the layout for the surfacing of the recordings.

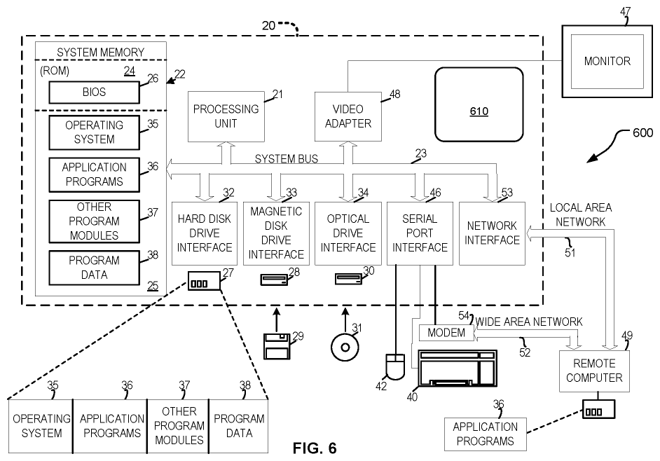

FIG. 6 illustrates an example system 600 that may be useful in implementing the high latency query optimization system disclosed herein. The example hardware and operating environment of FIG. 6 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 6, for example, the computer 20 includes a processing unit 21, a system memory 22, and a system bus 23 that operatively couples various system components, including the system memory 22 to the processing unit 21. There may be only one or there may be more than one processing units 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures, including a memory bus or memory controller, a peripheral bus, a switched fabric, point-to-point connections, and a local bus using any of a variety of bus architectures. The system memory 22 may also be referred to as simply the memory and includes read-only memory (ROM) 24 and random-access memory (RAM) 25. A basic input/output system (BIOS) 26, contains the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The computer 20 may be used to implement a high latency query optimization system disclosed herein. In one implementation, a frequency unwrapping module, including instructions to unwrap frequencies based at least in part on the sampled reflected modulations signals, may be stored in memory of the computer 20, such as the read-only memory (ROM) 24 and random-access memory (RAM) 25.

Furthermore, instructions stored on the memory of the computer 20 may be used to generate a transformation matrix using one or more operations disclosed in FIG. 7. Similarly, instructions stored on the memory of the computer 20 may also be used to implement one or more operations of FIG. 1. The memory of the computer 20 may also one or more instructions to implement the high latency query optimization system disclosed herein.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide non-volatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device, or other common network node, and typically includes many or all of the elements described above relative to the computer 20. The logical connections depicted in FIG. 8 include a local-area network (LAN) 51 and a wide-area network (WAN) 52. Such networking environments are commonplace in office networks, enterprise-wide computer networks, intranets, and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of communications devices for establishing a communications link between the computers may be used.

In an example implementation, software, or firmware instructions for the feature store collaboration network mining system 610 may be stored in system memory 22 and/or storage devices 29 or 31 and processed by the processing unit 21. high latency query optimization system operations and data may be stored in system memory 22 and/or storage devices 29 or 31 as persistent data-stores.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments of high latency query optimization system may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain function. The instructions may be implemented using any suitable high-level, low-level, object-oriented, visual, compiled and/or interpreted programming language.

The high latency query optimization system disclosed herein may include a variety of tangible computer-readable storage media and intangible computer-readable communication signals. Tangible computer-readable storage can be embodied by any available media that can be accessed by the high latency query optimization system disclosed herein and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the high latency query optimization system disclosed herein. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals moving through wired media such as a wired network or direct-wired connection, and signals moving through wireless media such as acoustic, RF, infrared and other wireless media.

A method disclosed herein includes receiving a plurality of user signals from one or more collaboration networks, wherein the plurality of signals are clustered with reference to a relevant user node, extracting a plurality of key data relating to the relevant user node, generating an optimization prompt using the key data, inputting the optimization prompt into a machine learning model, in response to receiving the optimization prompt, generating a process automation recommendation using the machine learning model, and modifying a process using the process automation recommendation.

Technology disclosed herein provides One or more physically manufactured computer-readable storage media, encoding computer-executable instructions for executing on a computer system a computer process, the computer process including receiving a plurality of user signals from one or more collaboration networks, wherein the plurality of signals are clustered with reference to a relevant user node, extracting a plurality of key data relating to the relevant user node, generating an optimization prompt using the key data, inputting the optimization prompt into a machine learning model, in response to receiving the optimization prompt, generating a process automation recommendation using the machine learning model, and modifying a process using the process automation recommendation.

A system disclosed herein includes memory, one or more processing units, and a process mining and collaboration recommendation system stored in the memory and executable by the one or more processor units, the process mining and collaboration recommendation system encoding computer-executable instructions on the memory for executing on the one or more processor units a computer process, the computer process including receiving a plurality of user signals from one or more collaboration networks, wherein the plurality of signals are clustered with reference to a relevant user node, extracting a plurality of key data relating to the relevant user node, generating an optimization prompt using the key data, inputting the optimization prompt into a machine learning model, in response to receiving the optimization prompt, generating a process automation recommendation using the machine learning model, and modifying a process using the process automation recommendation.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A method, comprising:
receiving a plurality of user signals from one or more collaboration networks, wherein the plurality of signals are clustered with reference to a relevant user node;
extracting a plurality of key data relating to the relevant user node;
generating an optimization prompt using the key data;
inputting the optimization prompt into a machine learning model;
in response to receiving the optimization prompt, generating a process automation recommendation using the machine learning model; and
modifying a process using the process automation recommendation.

2. The method of claim 1, wherein the optimization recommendation provides recommendation for optimizing a business process for the relevant user node.

3. The method of claim 1, wherein the machine learning model is a large language model (LLM).

4. The method of claim 1, further comprising:
in response to receiving the optimization prompt, generating a mobile application recommendation using the machine learning model.

5. The method of claim 1, wherein the key data includes at least one of key phrases, key applications, and key collaborators related to the relevant user node.

6. The method of claim 1, further comprising exposing the optimization recommendation via an application programming interface (API).

7. The method of claim 1, wherein the collaboration networks include at least one of an email application, a file sharing application, an online meeting application, and an online chat application.

8. One or more physically manufactured computer-readable storage media, encoding computer-executable instructions for executing on a computer system a computer process, the computer process comprising:
receiving a plurality of user signals from one or more collaboration networks, wherein the plurality of signals are clustered with reference to a relevant user node;
extracting a plurality of key data relating to the relevant user node;
generating an optimization prompt using the key data;
inputting the optimization prompt into a machine learning model;
in response to receiving the optimization prompt, generating at least one of a process automation recommendation and a mobile application recommendation using the machine learning model; and
modifying at least one of a process using the process automation recommendation and a mobile application using the mobile application recommendation.

9. The one or more physically manufactured computer-readable storage media of manufacture of claim 8, wherein the optimization recommendation provides recommendation for optimizing a business process for the relevant user node.

10. The one or more physically manufactured computer-readable storage media of manufacture of claim 8, wherein the machine learning model is a large language model (LLM).

11. The one or more physically manufactured computer-readable storage media of manufacture of claim 8, further comprising:
in response to receiving the optimization prompt, generating a website application recommendation using the machine learning model.

12. The one or more physically manufactured computer-readable storage media of manufacture of claim 8, wherein the key data includes at least one of key phrases, key applications, and key collaborators related to the relevant user node.

13. The one or more physically manufactured computer-readable storage media of manufacture of claim 8, wherein the computer process further comprising exposing the optimization recommendation via an application programming interface (API).

14. The one or more physically manufactured computer-readable storage media of manufacture of claim 8, wherein the collaboration networks include at least one of an email application, a file sharing application, an online meeting application, and an online chat application.

15. A system comprising:
memory;
one or more processing units; and
a process mining and collaboration recommendation system stored in the memory and executable by the one or more processor units, the process mining and collaboration recommendation system encoding computer-executable instructions on the memory for executing on the one or more processor units a computer process, the computer process comprising:
receiving a plurality of user signals from one or more collaboration networks, wherein the plurality of signals are clustered with reference to a relevant user node;
extracting a plurality of key data relating to the relevant user node;
generating an optimization prompt using the key data;
inputting the optimization prompt into a machine learning model;
in response to receiving the optimization prompt, generating at least one of a process automation recommendation and a website recommendation using the machine learning model; and
modifying at least one of a process using the process automation recommendation or a website using the website recommendations.

16. The system of claim 15, wherein the optimization recommendation provides recommendation for optimizing a business process for the relevant user node.

17. The system of claim 15, wherein the wherein the machine learning model is a large language model (LLM) that employs generative AI.

18. The system of claim 15, wherein the key data includes at least one of key phrases, key applications, and key collaborators related to the relevant user node.

19. The system of claim 15, wherein the computer process further comprising exposing the optimization recommendation via an application programming interface (API).

20. The system of claim 15, wherein the wherein the collaboration networks include at least one of an email application, a file sharing application, an online meeting application, and an online chat application.
